(19) United States
(12) Patent Application Publication
(10) Pub. No.: US 2008/0276888 A1
(43) Pub. Date: Nov. 13, 2008

(54) Cams for Built-Up Camshafts

(75) Inventor: Manfred Muster, Ludesch (AT)

Correspondence Address: CROWELL & MORING LLP;INTELLECTUAL PROPERTY GROUP, P.O. BOX 14300, WASHINGTON, DC, 20044-4300, US

(73) Assignee: THYSSENKRUPP AUTOMOTIVE AF, BOCHUM (DE)

(21) Appl. No.: 11/793,921

(22) PCT Filed: Nov. 25, 2005
(86) PCT No.: PCT/EP2005/012619

§ 371 Date: Jan. 25, 2008

(30) Foreign Application Priority Data
Dec. 24, 2004 (DE) 10 2004 062 518.2

(51) Int. Cl. F01L 1/047; F16H 53/00; B21B 1/00; B23P 15/00

(52) U.S. Cl. 123/90.6; 74/567; 72/365.2; 428/573

(57) ABSTRACT

The invention relates to cams for constructed camshafts, said cams formed from at least one profiled sheet metal strip (2) produced by rolling and having a thickness which varies in the longitudinal direction thereof and two end regions (2a). Said profiled sheet metal strip (2) is bent or deformed to form the cam blank (1) in such a way that the end regions (2a) thereof are welded to the end regions (2b) of at least one other bent or deformed metal strip (2). The cam blank (1) has recess (A) for receiving a carrying shaft (11), said recess (A) having an inner contour region which is essentially circular or partially circular. The aim of the invention is to create one such cam in such a way that it requires as little raw material as possible, the usable width of the running surface is as large as possible, and it can be connected to the carrying shaft in an especially simple and cost-effective manner by a non-positive and/or positive joining method. To this end, a feeder bevel (8) is formed on the inner contour region.

The invention relates to cams for built-up camshafts, preferably for use in internal combustion engines. The invention also relates to sheet metal strips for the production of cams of this type and relates to a method of producing these cams. Furthermore, the invention relates to camshafts which are produced using these cams.

Finally, the invention also relates to cam discs/eccentric discs and built-up cam disc shafts/eccentric shafts which are produced using these cam discs/eccentric discs.

Built-up camshafts are known from the prior art. As individual parts cams are sintered (DE 37 17 190 C2), forged (DE 41 21 951 C1) or bent from sheet metal strip and are then welded (WO 01/98020 A1). The cams are then slid onto a shaft, connected to the shaft and thus made into camshafts.

The cams are mounted on the support shaft in a different way. In DE 37 17 190 C2 and DE 41 21 951 C1, the support shaft is widened by roller-burnishing at the axial positions, at which the cams are to be attached, and subsequently the cams are slid over the pipe to the designated axial position which corresponds to the widened region. This produces a positive and/or non-positive connection between the support shaft and cam.

In WO 01/98020A1, the cams are connected to the support shaft by welding.

However, the prior art is encumbered by a whole series of disadvantages. The production of cams by sintering is complex and expensive. Moreover, cams of this type cannot be utilised for very high Hertzian surface pressures, as occur in modern roller actuating systems in internal combustion engines. There is also a great risk of the sintered cams cracking, thus necessitating expensive quality control.

The forged cams also have a number of disadvantages. In the first instance, production is expensive and complex. During the multistage forging operation, the inner cut-out of the cam must be punched out, so that the punched out scrap accumulates as waste. Furthermore, the cams can only be forged with radii on the end sides, so that the width which is actually available as a running surface is less than the cam width or a large amount of cam material must be removed at the periphery or at the end sides of the cam. The width which cannot be used for the cam track depends greatly upon the cam contour, the material used and other parameters and lies in a value range of about 1 mm to about 1.5 mm.

The use of bent sheet metal strips as proposed in WO01/98020A1 also has a number of disadvantages. The welded connection of the cam to the support shaft is complex and expensive. In particular, The desired assembly of already hardened cams by means of welding involves the risk of micro-cracks in the connection. Moreover, without finishing treatment materials which can be processed effectively in terms of welding are generally not very suitable as sliding partners for cam followers. It is also disadvantageous if welding flanges which are required for the production of welded connections have to be provided on the cams because this involves additional material and manufacturing outlay. The procedure of joining the cams, which are proposed in WO01/98020, by means of a non-positive and/or positive connection is scarcely possible by reason of the inadequately small wrap angle of the contact between the cam cut-out, the joining contour of the cam and the support shaft. Furthermore, the solution proposed in WO01/98020 has the considerable disadvantage that the rigidity in the cam apex is excessively reduced for use in internal combustion engines owing to the cavity which remains after the joining operation.

The object of the invention is to provide a cam in accordance with the preamble of claim 1 which requires as little raw material to be used as possible, wherein the usable width of the running surface is as large as possible, and which cam can be connected to the support shaft in a particularly simple and cost-effective manner by means of a non-positive and/or positive joining method. It is also an object of the invention to provide a simple and cost-effective method of producing cams of this type.

It is also an object of the invention to provide a profiled sheet metal strip which is particularly well suited to the production of the cams in accordance with the invention. It is also the object of the invention to provide a camshaft, in which the rigidity of conventional built-up camshafts can be at least almost achieved with forged or sintered cams.

With regard to the cam, the object is achieved by a cam corresponding to the features of claim 1. Advantageous developments of the cam in accordance with the invention are described in the subordinate claims 2 to 14. In relation to the method, this object is achieved by a method in accordance with claim 20. Advantageous developments of the method are described in the subordinate claims 21 to 25.

With regard to the profiled sheet metal strip, the object is achieved by a profiled sheet metal strip in accordance with claim 15. Advantageous embodiments of the profiled sheet metal strip are described in the subordinate claims 16 to 19. In relation to the camshaft, the object is achieved by a camshaft having the features of claim 26 and subordinate claim 27.

In accordance with the invention, the cam is formed from one or several preferably elongate profiled sheet metal strips, wherein each peripheral portion of the cam contour of the cam is allocated in each case precisely one profiled sheet metal strip or profiled sheet metal strip portion and the strip(s) is/are produced by rolling and a cam is formed by bending or deforming the strips and welding the strip ends. By welding the bent or deformed strips, a cam blank is produced which subsequently can optionally also be subjected to pressure calibration. However, in practice the additional step of pressure calibration will not be required in all cases.

The cam in accordance with the invention comprises a circumferential feeder chamfer on the circular or circular portion-shaped inner contour region of the cut-out, thus ensuring that the cam can be slid effectively onto the support shaft without canting. The feeder chamfer makes it easier to thread the cam onto the support shaft. A further advantage of the feeder chamfer is that the cam can be connected to the support shaft positively and/or non-positively in an improved manner. In order to connect the cam to the support shaft in a positive and/or non-positive manner, widened diameter portions on the support shaft are produced at specific axial positions by local material displacement by roller-burnishing or knurling. The cams are then slid over these portions of the support shaft having the widened diameter, wherein a positive and/or non-positive connection is formed between the cam and the support shaft. The feeder chamfer is particularly significant because it ensures that the support shaft material in the widened region does not shear off when the cam is slid onto the support shaft portion with the widened diameter. This effectively prevents undesired chip formation which in practice would lead to considerable problems during cam assembly.

In accordance with the invention, the feeder chamfer is introduced into the profiled strip(s) by rolling. This can be done cost-effectively and there is no need for any additional deformation or chip removal step to produce the feeder chamfer.

If the cam blank which is produced by welding the bent or deformed profiled sheet metal strips has to be subjected to pressure calibration in order to achieve its final shape, provision can be made in accordance with the invention for the feeder chamfer to be integrally formed on the band portion of the cam blank during this pressure calibration step. It is possible for the feeder chamfer to be formed completely during the pressure calibration step. However, within the scope of rolling technology to produce the profiled sheet metal strips, it is also possible to deform the strip regions, which form the subsequent band portion, to a predetermined extent during rolling, wherein the final shape of the subsequent feeder chamfer is not yet achieved. If the cam blank, which is obtained after bending or deformation of the profiled sheet metal strips and after welding, is then subjected to pressure calibration, then the final shape of the feeder chamfer can be achieved during the pressure calibration step.

If the cam blank is formed from a single profiled sheet metal strip, then this profiled sheet metal strip comprises a point which corresponds to the location of maximum cam elevation of the subsequent cam blank. In accordance with the invention, the profiled sheet metal strip is formed in a symmetrical or even asymmetrical manner in relation to a transverse axis which extends through this location of maximum cam elevation. In this manner, the joining site at which the end regions of the profiled sheet metal strip are welded together are disposed at any point along the periphery of the cam blank.

The inner wall of the cut-out A of the cam blank forms a joining contour for connecting the cam to the support shaft in a non-positive and/or positive manner.

In order to improve this non-positive and/or positive connection and to increase the connection strength, provision is made in accordance with the invention to provide the inner wall of the cut-out A with engraving. This engraving can be formed e.g. by toothings which extend in the axial direction of the cam blank. When the cams are slid onto a support shaft, which is widened locally by means of roller-burnishing or knurling, these toothings engage behind the support shaft material and deform it so as to produce a positive connection.

In the case of the invention, the feeder chamfer can be formed as a portion, which widens conically outwards, of the inner contour of the cut-out A. Even in the case of this embodiment of the feeder chamfer, it is not possible for the local widened diameter portions to shear off, thus preventing chip formation.

An improvement in the non-positive and/or positive connection between the cam and support shaft is achieved if the portion which widens conically outwards is subdivided into two partial portions widen conically and are disposed adjacent to one another in the axial direction, wherein the outer portion comprises a larger cone angle than the inner portion. This prevents in a particularly reliable manner the formation of chips when the cams are slid into position, and at the same time ensures that the region with a smaller cone diameter which adjoins the region with a large cone diameter serves to create a particularly good and stable non-positive and/or positive connection. At the same time, the load which acts upon the cam as it is slid on is kept low.

As an alternative to the conically widened portions, the feeder chamfer can also be formed by means of a radius, which is provided on the inner contour of the cut-out, or by means of a parabolic portion which widens outwardly.

In order to achieve reliable stability in the connection between the cam and the support shaft, provision is made in accordance with the invention for the circular or circular portion-shaped inner contour region of the cut-out to extend over a peripheral region at a peripheral angle of at least 300°. This ensures a high degree of mechanical strength of the non-positive and/or positive connection between the cam and the support shaft.

With regard to the profiled strip(s) required for the production of cams in accordance with the invention, the invention is accomplished by virtue of the fact that an edge region of the profiled sheet metal strip is deformed by rolling such that after bending or deformation of the profiled sheet metal strip to form the cam blank, this deformation forms the feeder chamfer of this cam blank. Introducing the feeder chamfer in this way by rolling even at the stage of processing the profiled sheet metal strip by rolling allows the feeder chamfer to be introduced in a cost-effective manner in terms of manufacturing technology. Therefore, the continuous production, by the through-feed method, of the feeder chamfer actually on the profiled sheet metal strip (and not on the bent cam blank) is particularly favourable in terms of manufacturing technology.

During production of the profiled sheet metal strip by rolling, it is necessary to ensure that each longitudinal portion of the profiled sheet metal strip is allocated a specific peripheral portion of the cam blank and that the thickness progression in the longitudinal portions of the profiled sheet metal strip already corresponds substantially to the thickness progression in the corresponding peripheral portions of the cam blank.

Since a transverse contraction of the material occurs during bending or deformation of the rolled profiled sheet metal strip to produce the cam blank, provision is made in accordance with the invention to counteract this transverse contraction by means of controlled geometric shaping of the rolled profiled sheet metal strip. As a consequence, any undesired material narrowing as a result of transverse contraction during bending or deformation is compensated for and prevented. For this purpose, it is provided in accordance with the invention that the two edge regions of the profiled sheet metal strip are deformed by rolling such that they comprise protruding regions in relation to a perpendicular line with respect to the joining contour. These protruding regions contain additional material to compensate for the transverse contraction of the material which occurs during bending or deformation of the profiled sheet metal strip to form the cam blank, wherein after deformation the two edge regions of the profiled strip are aligned perpendicularly with respect to the joining contour with the greatest precision possible. Therefore, this additional material which is provided on the edges of the profiled sheet metal strip serves to effectively prevent any undesired material narrowing which would result in an undesired cam blank geometry.

As already illustrated above in relation to the cam blank, in order to improve the non-positive and/or positive connection between the cam and the support shaft it is advantageous if the cut-out of the cam blank comprises engraving, so that this engraving can be connected in a positive manner to the support shaft. In accordance with the invention, it is provided that this engraving can even be produced in the corresponding longitudinal portion of the profiled sheet metal strip during the process of rolling the profiled sheet metal strip. In accordance with the invention, this is achieved by virtue of the fact that the longitudinal portion of the profiled sheet metal strip, which corresponds to the subsequent joining contour of the bent or deformed cam blank, comprises engraving which is introduced into the profiled sheet metal strip by rolling. This engraving can be formed as a toothing which extends transversely with respect to the rolling direction.

With regard to the method, the object of the invention is achieved by a method of producing a cam for built-up camshafts which comprises the method steps of:
1. Producing, by means of a rolling procedure, at least one profiled sheet metal strip which comprises thickness progressions predetermined in its longitudinal extension and has two end regions, wherein an edge deformation which forms a subsequent run-in chamfer of a cam blank is rolled at least partially onto a longitudinal edge of the profiled sheet metal strip.
2. Bending or deforming the profiled sheet metal strip, so that its end regions abut and are welded together or that its end regions abut and are welded to the end regions of at least one further bent or deformed sheet metal strip.

In order in particular to configure the cut-out of the cam blank into the desired shape and to achieve the desired dimensions, provision can be made in accordance with the invention to subject the cam blank to a pressure calibration step. If, within the scope of the production of the profiled sheet metal strip by rolling, the partially rolled edge deformation does not yet comprise the final shape of the subsequent feeder chamfer, this final shape of the feeder chamfer can be produced within the scope of the pressure calibration step.

With regard to the already aforementioned additional material regions, which are provided on the edge regions of the profiled sheet metal strip, to compensate for the transverse contraction of the material which occurs during bending or deformation of the profiled sheet metal strip to form the cam blank, it is provided in accordance with the invention that these additional material regions are produced by rolling the profiled sheet metal strip. A further working step which is to be integrated into the process of rolling the profiled sheet metal strip resides in the fact that engraving is rolled into the longitudinal portion of the profiled sheet metal strip which corresponds to the subsequent joining contour of the bent or deformed cam blank. This engraving can be formed e.g. in the manner of a toothing which extends transversely with respect to the rolling direction.

It is particularly cost-effective to produce the profiled sheet metal strips by rolling if they are produced by continuous rolling as portions of a windable endless sheet. In order to ensure the windability of this endless sheet, it is provided in accordance with the invention that the profiled sheet metal strips are connected together by means of portions of a smaller sheet metal thickness. These portions of smaller sheet metal thickness form connection regions which during winding of the endless sheet can be deformed particularly easily by reason the smaller material thickness. It is understood that this type of continuous rolling involves particularly low piece costs in relation to the profiled sheet metal strips.

The invention also relates to built-up camshafts which have been produced using the cams in accordance with the invention. The support shafts of these built-up camshafts in accordance with the invention comprise wider diameter portions at the axial positions at which the cams are to be attached. The cams are slid with the feeder chamfer to the fore onto the support shaft and are then slid over the respective portion having the widened diameter, so that a non-positive and/or positive connection is formed between the cam and the support shaft. The feeder chamfer serves to prevent any undesired chip formation as a result of shearing of the support shaft material in the region of the widened diameter. The widened diameter portions on the support shaft can be produced by material displacement processes, such as roller-burnishing or knurling.

Ideally, the thickness of the respective profiled sheet metal strip corresponds to the band thickness of the cam after the bending or deforming operation at least approximately for a peripheral region with a peripheral angle of at least 300°. A particularly high degree of mechanical strength of the non-positive and/or positive connection between the cam and the support shaft is achieved if the peripheral angle, in the region of which the thickness of the respective profiled sheet metal strip corresponds at least approximately to the band thickness of the cam after the bending or deforming operation, extends over an angle range of 360°.

In other words: The shape of the unwind of the cam which comprises the blank contour corresponds approximately to the shape of the one or several profiled sheet metal strips which are placed against each other and form the cam. In order to achieve the desired cam shape after the bending or deformation procedure and after welding of the profiled sheet metal strips, corresponding distortions and fusions of material are objected to such that ultimately the desired blank contour of the cam is formed. The deforming operations can be conducted both at room temperature and also at elevated temperature as required.

Generally, in order to use the cam in camshafts for internal combustion engines, the profiled sheet metal strip will consist of a high-grade steel, preferably 100Cr6 or 16MnCr5.

Following on from the bending or deforming operation and the welding procedure, any resulting weld beads are removed either by scraping, peeling or reaming—preferably prior to joining onto the support shaft—or during production of the finished contour of the cam. Subsequently, the cam is formed as required to the desired blank contour in a pressure calibration process which is conducted at room temperature or at elevated temperature. The cam is then hardened and optionally annealed as required. The cam which is thus formed is annealed as required between the individual operations. Furthermore, the cam contour is made into the finished contour before or after assembly onto the shaft by means of mechanical processing, e.g. grinding and/or high speed milling. However, it is also conceivable to configure the preforming procedure and processes, such as e.g. the pressure calibration process, so as to be able to dispense with a finishing process in order to achieve the finished contour of the cam.

The cam which is formed in this manner is joined onto the support shaft preferably by means of a non-positive and/or positive connection. The support shaft which can also be formed in a weight-saving manner as a pipe is widened at predetermined axial positions e.g. by roller-burnishing and subsequently the cam is slid over the support shaft and secured in the widened region. It is particularly advantageous for the said region to be widened by means of material displacement, such as can be achieved by rolling, in particular roller-burnishing or knurling. The beads can be aligned in the transverse direction, in the longitudinal direction or at a different angle or even in a crosswise manner.

In order to achieve the particularly preferred non-positive and positive connection, the cut-out of the cam is provided with engraving, the joining contour of the cam, e.g. a toothing in the longitudinal direction and the widening of the support shaft is produced by roller-burnishing in the transverse direction.

In a development of the invention, the desired joining contour of the cam, e.g. the engraving or toothing, is introduced into the cam during pressure calibration, in which further functional surfaces can also be integrally formed or improved in terms of their precision.

In a particularly advantageous manner, the engraving can be rolled in onto the surface, which serves subsequently as the joining contour of the cam, even during the process of rolling the profiled strips. It is also provided to produce a blank for the joining contour during the rolling process, which blank is deformed to the finished shape of the joining contour during the pressure calibration process.

An important aspect in the manufacture of built-up camshafts is to obviate chip formation even during the joining process. Retrospective measures to remove chips are expensive, complex and generally do not guarantee 100% that chips will be avoided. In the case of the above-described non-positive and positive connection without a feeder chamfer, the engraving of the joining contour is carved into roller-burnished portions of the support shaft, which inevitably leads to the formation of chips. In particular during mass production it is not possible to monitor how the respective apexes of the joining contour and roller-burnished portion intersect and when some apexes are sheared off.

For this purpose, in one advantageous development of the inventive solution a feeder chamfer, in particular an insertion cone which can comprise various contours in the longitudinal section, is introduced into the cam. A feeder chamfer is disposed on the side of the cam which when slid onto the pipe points in the direction of the widened pipe regions. In the particularly preferred application, the desired feeder chamfers are introduced into the profiled strips directly during the rolling process. During pressure calibration, where provided, the feeder chamfer is formed into the joining contour or subsequently calibrated as required.

Feeder chamfers of this type ensure that the beads of the roller-burnished portion are formed in the engraving of the joining contour and do not shear off. In addition, the build-up of stress in the cam during the joining process is optimised such that the tendency to produce micro-cracks being is substantially reduced.

However, feeder chamfers are also required for other joining processes for joining the cams on the support shaft. Therefore, a chamfer is practical, or even necessary, merely to thread the pipe into the cam orifice. For all joining processes, in which the cam is slid over a widened region, suitable feeder chamfers ensure a uniform and gentle assembly operation, in which cracks can be prevented in the cam.

Particularly advantageous feeder chamfers are ones which are opened as a cone with a cone angle in the range of 5-10° and whose largest diameter is slightly larger than the largest diameter of the widened roller-burnished beads or engraving. For specific applications, it can be advantageous if the feeder chamfer is formed with several cones or cone portions which are disposed one behind the other and have different cone angles. In this case, two cone portions which are connected one behind the other and have a first angle α₂ between 5 and 10° and a second angle α₁ between 0.5 and 4° have proven successful, wherein during assembly the cone with the larger angle is the first to pass over the widened portion of the pipe. Equally, instead of cone-like orifices, orifices which are widened in a different manner, e.g. with a radius (radius r) or a parabolic widened portion can be advantageous.

However, during formation of the orifice it is necessary to ensure that the width of the surface actually located in the non-positive and/or positive connection is not too small, so that the connection is still sufficiently firm.

It is immediately apparent to the person skilled in the art that the process of bending or deforming the profiled sheet metal strips is one which is not simple to control. It is known that thin metal sheets bend most effectively and as the thickness of the metal sheet increases the quality of the deformation result reduces. This means that particularly in the case of cam contours having large maximum cam elevations and the required high level of rigidity, the degree of deformation, the bending forces, the risk of crack formations and the deformations transverse to the bending direction increase greatly. In accordance with the invention the profiled strip is formed with a particular thickness progression prior to the bending process. The aim is on the one hand to make the strip thickness achieved after the bending process correspond to the band thickness of the cam at widest possible regions of the periphery, and on the other hand simultaneously to limit the bending deformation where possible to regions with a small strip thickness. To this end, when designing the profile the profiled strip is divided into portions with greater thicknesses and at the same time slight deformation and portions with smaller thicknesses and at the same time more substantial deformation and a corresponding thickness distribution is determined. In addition, in a preferred embodiment the profiled sheet metal strips are continuously rolled such that between the strip portions which are required for the cams particular tapered portions are provided in the sheet metal thickness, in which virtually all of the bending takes place during winding of the strip, so that the remaining regions of the strip are not bent or deformed by the winding procedure. Therefore, the available degree of deformation of the profile is virtually completely provided for the production of the cam. Furthermore, separation tools which fabricate the endless profiled strip for cam production have to separate a profiled portion with only a slight and in addition already attenuated material structure which reduces tool wear and increases the possible separation speed.

An important aspect of the solution in accordance with the invention resides in the division of the peripheral portions of the cam and in the respective allocation to form a specific profiled sheet metal strip or profiled sheet metal strip portion and in the welding connection of the profiled sheet metal strips after the bending or deforming operation has been performed in each case. For cams which have a large cam elevation, the cam is formed generally from more than one, preferably two elongate profiled sheet metal strips.

It has proven to be particularly advantageous to form the base circle region of the cam from a profiled sheet metal strip having an approximately rectangular cross-section and over the length of equal thickness, the lower sheet. The cam elevation is formed from a second profiled sheet metal strip, the upper sheet which is formed according to the teaching stated above. The two profiled sheet metal strips which are separated from the upper sheet and the lower sheet in each case are connected together in one operation by resistance welding or beam welding. The advantages of this type of division include inter alia the shorter machine running time, welding without uncontrolled electrical bypasses and the ability to use the same lower sheet for different cams.

The invention is explained further with reference to exemplified embodiments in the following drawings, in which

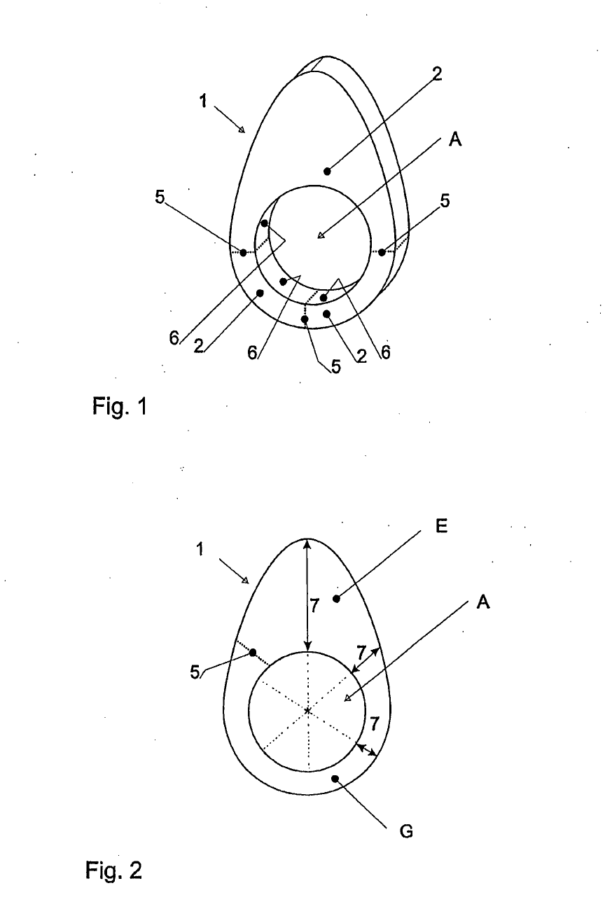

FIG. 1 shows a perspective illustration of a cam 1 in accordance with the invention;

FIG. 2 shows an axial view of a cam 1 in accordance with the invention with the individual profiled strips 2 divided differently;

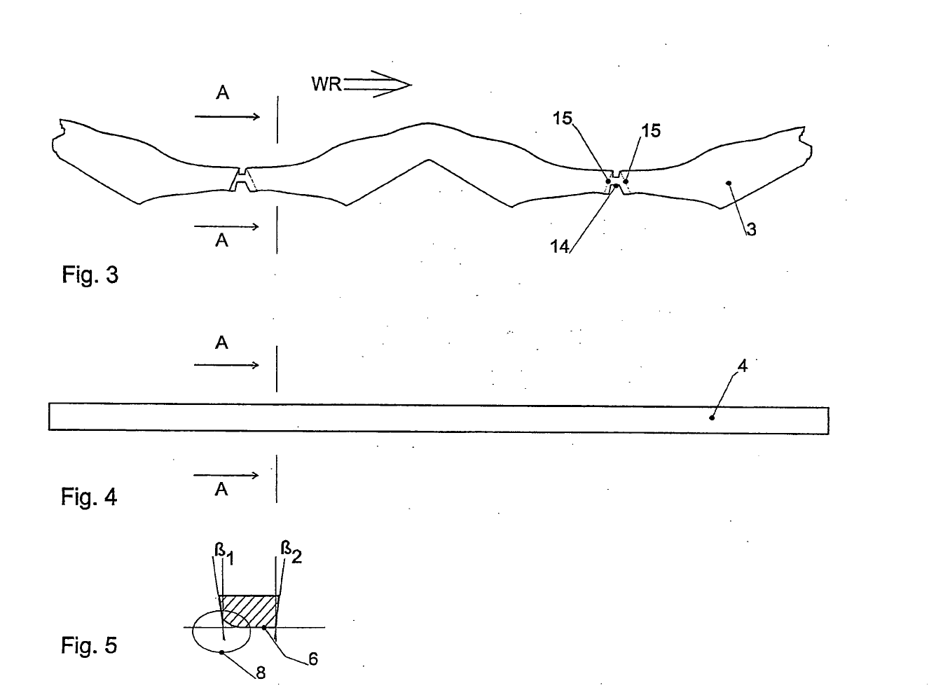

FIGS. 3 and 4 show two embodiments of the rolled endless strip, from which the elongate profiled strips are cut for the manufacture of the cams, wherein the two sheets are intended for different peripheral portions of the cam.

FIG. 5 illustrates a cross-section through the profiled strip according to the section A-A in FIGS. 3 and 4.

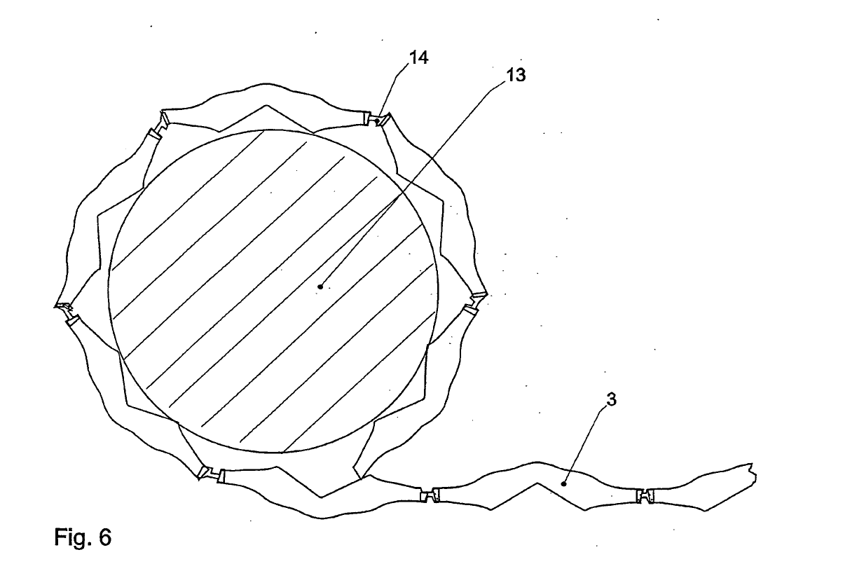

FIG. 6 shows the endless sheet, which is wound up on the winder 13, of one of the profiled strips, in this case the example of the upper sheet 3.

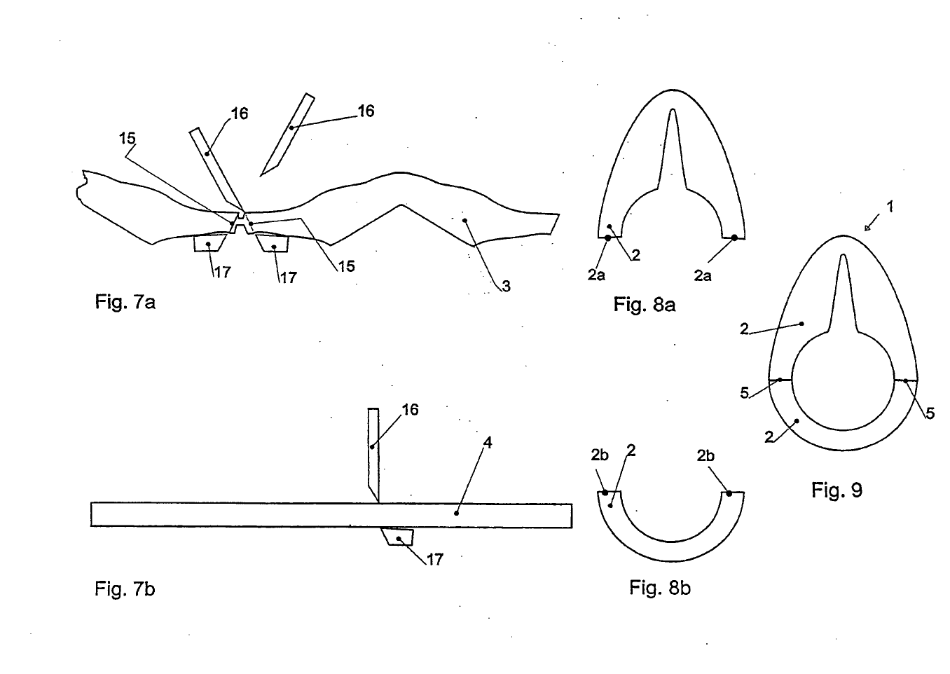

FIGS. 7, 8, 9 show steps for the production of the cam. FIGS. 7a and 7b show the fabrication of the upper sheet 3 or the lower sheet 4. FIGS. 8a and 8b show the completed bent elongate profiled strips 2. FIG. 9 shows the completed assembled cam 1.

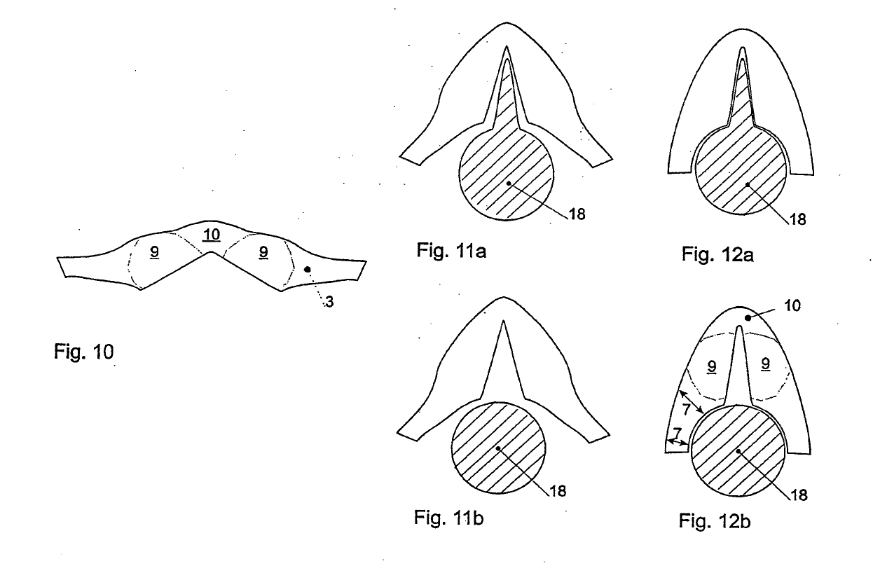

FIGS. 10, 11 and 12 illustrate the bending operation of the profiled strip using the example of the upper sheet 3. FIG. 10 shows the completed fabricated upper sheet 3 and FIGS. 11 and 12 illustrate two steps of the bending operation. In comparison with FIGS. 11b and 12b, only a different bending core has been used in FIGS. 11a and 12a.

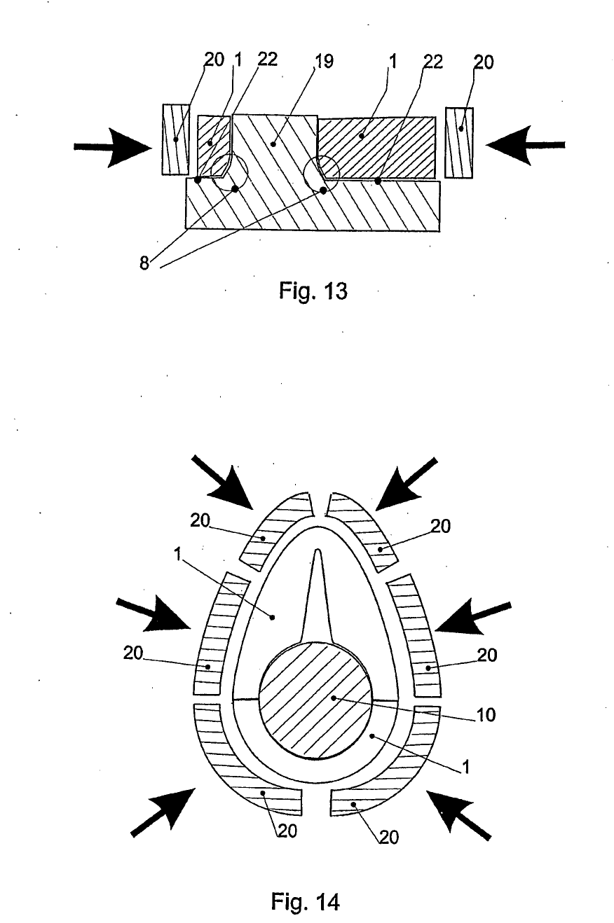

FIGS. 13 and 14 show the procedure of pressure calibration as seen in the axial and transverse direction.

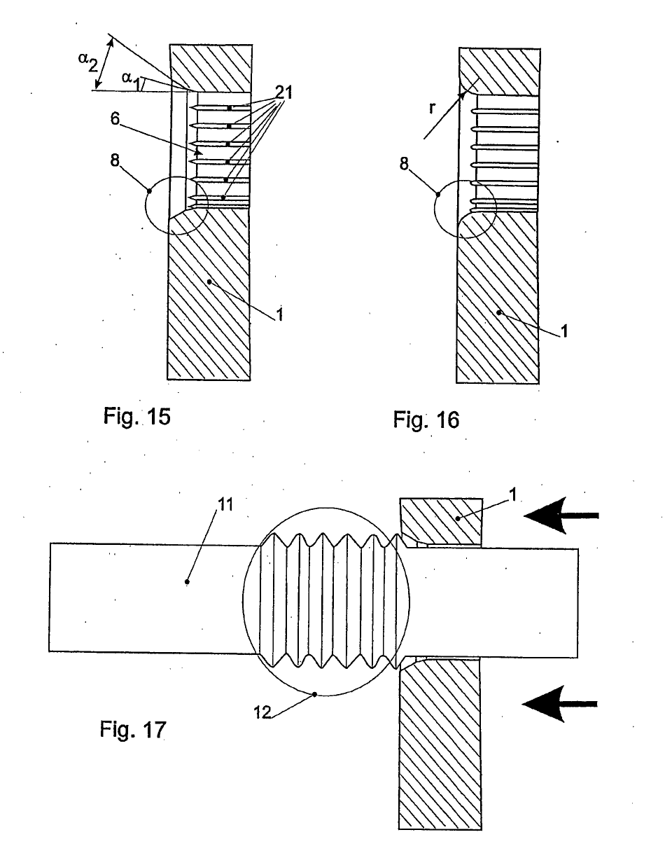

FIGS. 15 and 16 each show a cam 1 in cross-section, on which two different examples of the feeder chamfer 8 and one example of engraving 21 in the joining contour 6 are put forward.

FIG. 17 illustrates the process of joining the cam 1 onto the support shaft 11 which is widened in the region 12.

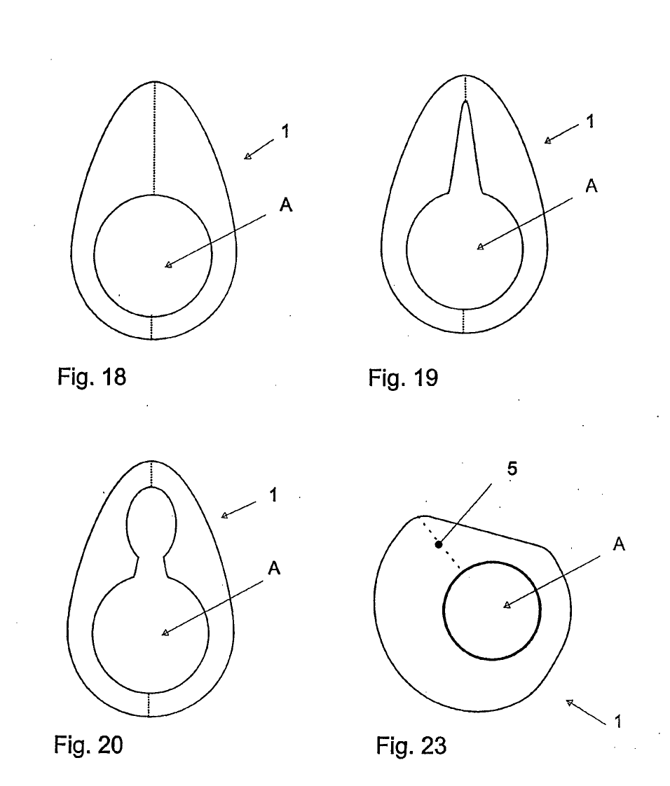

FIGS. 18, 19 and 20 show various examples of cam shapes, wherein other shapes and separation planes 5 are also feasible.

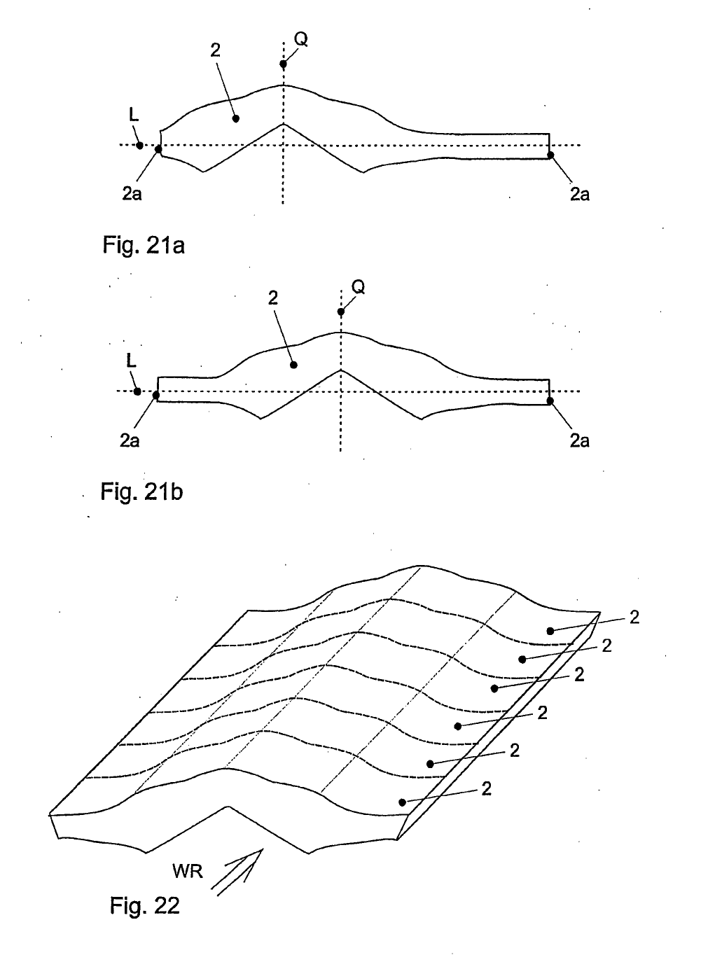

FIG. 21a shows an example of an asymmetrical profiled strip 2, as required for the cam 1, as illustrated the division according to FIG. 2.

FIG. 21b shows an example of a symmetrical profiled strip, as required for the cam 1, as illustrated in the division according to FIG. 1.

FIG. 22 shows an example of a rolled profile, in which the profiled strips 2 used for forming the cam are cut from the profile transversely with respect to the rolling direction (WR), wherein the separation lines in the Figure are denoted by the dashed lines.

FIG. 23 shows an example of a cam which is formed as a cam disc.

The cam 1, as illustrated in FIG. 1, is formed by the three profiled strips 2 which are joined at the joining sites 5, preferably by means of resistance welding or resistance pressure welding. The substantially circular joining contour 6 is formed in such a manner that it is adapted to the respective joining method by which the cam is joined onto the support shaft. For the method which is preferred in accordance with the invention in which the cam is pressed onto a portion of the support shaft 11 which is widened by means of roller-burnishing, engraving, preferably axially extending small toothings are introduced (not illustrated in FIGS. 1 and 2) in the joining contour. FIG. 2 illustrates the band thickness 7 on the cam 1 which corresponds to the wall thickness of the cam, as measured orthogonally with respect to the axial direction of the camshaft. In the example as shown in FIG. 2, an asymmetrical profiled sheet metal strip has been used for the production of the cam blank, so that the weld seam 5 is located in the position indicated in FIG. 2. Depending upon the requirements in terms of rolling and bending/deformation technology, this kind of division can be advantageous.

FIGS. 3 and 4 illustrate an upper sheet 3 and a lower sheet 4 which are each fabricated into profiled strips. This preferred case is utilised if the cam 1 is formed from two elongate profiled strips 2 in such a manner that, as illustrated in FIG. 9, the base circle region and the elevation region of the cam each consists of a single profiled strip 2. In order to ensure that during winding (cf. also FIG. 6) the sheet is not deformed in regions which are subjected to high degrees of deformation during the bending/deformation process, the upper sheet in particular is provided with predetermined bending points 14 which completely accommodate the circumferential bending during the winding procedure. This ensures that in those regions which are subjected to high degrees of deformation during the bending/deformation process, the available deformation capacity of the material is not used partially or even completely as a result of the winding procedure. The deformation capacity is retained at the locations where this is required. The lines which are designated by the reference numeral 15 (FIG. 3) represent the section contour for fabricating the sheet. Similar predetermined bending points can also be introduced into the lower sheet.

In an alternative embodiment, as illustrated in FIG. 22, the profile as the initial workpiece for production purposes is not rolled in the longitudinal direction, as shown in FIGS. 3 and 4, but rather is rolled in the transverse direction with respect to the cam circumference, of the profiled pieces 2 which are used for the purpose of forming the cam. The rolling direction WR is shown in FIG. 22 by an arrow. The profiled strips 2 are manufactured by separating the initial workpiece along the dashed lines. However, this embodiment is not to be preferred, since in this case the feeder chamfer 8 can only be integrally formed during the pressure calibration process and production of the correction angles is associated with material waste. However, it may still be necessary for some special cam contours to manufacture the profiled strips 2 from such initial workpieces.

FIG. 5 illustrates that even during the rolling process, the feeder chamfer 8 is rolled in the preliminary or finished shape into the joining contour 6 of the cam. It also facilitates threading onto the calibration mandrel 19 in the optional phase of pressure calibration.

After unwinding the respective sheet, it is fabricated into the elongate profiled strips by means of the cutting operations sketched in FIGS. 7a and 7b performed by the cutting tools 16, 17 along the section contour 15. The profiled strips 2 are then bent individually (FIGS. 8a and 8b) and joined to form a cam 1 (FIG. 9). The bending operation is preferably performed with a bending mandrel 18 (cf. FIG. 11a, 11b, 12a, 12b) which in accordance with the expected resilience must be designed to be smaller than the desired joining contour of the cam blank in the portion. The deformation (FIGS. 11a, 11b, 12a, 12b) can be controlled both in a die (not illustrated) and also by means of tool elements (not illustrated). In order to control the deformation and the tool displacements required for this purpose in the respective sheet, bending mandrels having corresponding specific shapes, e.g. as shown in FIGS. 11a and 12a, are also utilised where appropriate.

When conducting the bending operation and designing the strip, it is necessary to take into consideration that not all of the volume of the profiled sheet metal strip 2 is subjected to uniform deformation during the bending/deforming operation. Therefore, in the profiled strip 2 there are regions 9 which are subjected only to small deformations during the bending/deforming operation. Likewise, there are regions 10 which are subjected to considerable deformations. FIGS. 10 and 12b illustrate regions of this type.

By designing the profiled strips accordingly, the transverse contraction of the strip is kept low during the bending operation and/or is compensated for by means of suitable profile cross-section geometries of the profiled strip. For this purpose, the lateral surfaces of the profiled strip are formed in an inclined manner with respect to the surface perpendicular of the joining contour 6 during rolling about the correction angle β1 or β2. As a consequence, the surface of the profiled strip lying opposite the joining contour 6 is provided with an excess of material which is displaced during deformation such that after deformation the lateral surfaces of the then bent profiled strip are aligned at least approximately orthogonally with respect to the joining contour 6.

This design renders it possible to dispense with the subsequent processing, i.e. facing, of the lateral surfaces of the cam.

To ensure that the cam only has to be subjected to the least possible amount of further mechanical finishing and the joining conditions are optimised by virtue of precise joining contours, pressure calibration of the cam blank is preferably performed as illustrated by way of example in FIGS. 13 and 14. The cam is slid onto the calibration mandrel 19, wherein at the same time it is possible to perform the scraping operation to remove the weld beads on the weld sites 5. Then, by means of forming tools 20 the cam is pressed into shape, as illustrated by arrows in FIGS. 13 and 14. The cam can also be pressed simultaneously or consecutively against the base 22 of the calibration mandrel 19 by means of tools, not illustrated, (FIG. 13). In this manner, the cut-out A and the feeder chamfer (8) can be calibrated exactly.

FIGS. 15 and 16 show two examples of the feeder chamfer 8 having the characteristic angles α₁ and α₂ or the characteristic radius r. Also illustrated is a circumferential toothing 21 which is introduced into the joining contour 6 and whose teeth extend in the axial direction. However, the method of producing the cams renders it possible in a particularly convenient manner also to form different engravings 21 in the joining contour 6.

It is obvious that the cams in accordance with the invention can also be joined onto the support shaft by means of laser welding, electron beam welding or even other joining methods. Any necessary forming elements, such as welding shoulders etc., can then also be introduced in a convenient manner into the profiled strips by rolling.

Furthermore, a considerable advantage of the technology in accordance with the invention is that circumferential grooves can be produced in a cost-effective and simple manner in the joining contour 6 of the cam. When applying joining methods, in which the support shaft is widened after positioning of the cam, the strength of the connection can be increased in the axial direction by means of a circumferential groove. Furthermore, the method can also be used to form cams, in which the joining contour is not substantially circular. Therefore, joining contours which as seen in the axial direction are formed as polygons can be introduced with correspondingly rounded corners during the bending operation.

The proposed solution of the invention can also be applied to cam discs or eccentric discs as a special case of cams having a particular circumferential contour, as used e.g. to form an adjusting shaft for actuating elements of a mechanical variable valve train system. Specific cams of this type can likewise be formed and joined according to the invention.

An example of this type of cam disc is given in FIG. 23. The weld seam 5 can advantageously be disposed in a region which is never in contact with a cam follower or a corresponding transmission member which is actuated directly by the cam or cam disc.

For cams 1, in which the contact between the cam follower and the cam extends through the entire peripheral contour of the cam, the weld seam 5 is preferably disposed in a region having a relatively low contact loading in comparison with the other regions of the peripheral contour.

FIG. 17 illustrates how the cam 1 which is formed in accordance with the invention is joined onto the support shaft 11. In the direction of the arrow, the cam is slid with its feeder chamfer 8 to the fore over the widened region 12, wherein the widened portion is formed into the toothing 21 of the joining contour 6 of the cam 1 and produces a non-positive and positive connection.

FIGS. 18, 19 and 20 illustrate alternative forms of the cut-out of the cam 1. In the case of very large cam elevations, it is sometimes not possible to achieve a substantially circular cut-out of the cam, as illustrated in FIG. 18. In this case, it is possible to form cut-outs as illustrated in FIG. 18 or 19. At the same time, FIGS. 18, 19 and 20 show an alternative way of disposing the weld seam between the profiled strips, from which the cam is formed. It should be noted that the forms of the cut-out of the cam 1 as shown here are not related to the arrangement of the weld seam illustrated in this case.

The profiled strip illustrated in FIG. 21a gives an example of a profiled strip 2 which is asymmetrical in relation to the maximum cam elevation, as required for the cam 1, as shown in the division of the profiled strips according to FIG. 2. The section plane Q shown in the Figure extends directly through the maximum cam elevation of the cam which is formed from the profiled strip 2 by bending of the longitudinal axis L.

The profiled strip illustrated in FIG. 21b gives an example of a profiled strip 2 which is symmetrical in relation to the maximum cam elevation, as required for the cam 1, as shown in the division of the profiled strips according to FIG. 1. The section plane Q which is illustrated in FIG. 21b extends directly through the maximum cam elevation of the cam which is formed from the profiled strip 2 by bending of the longitudinal axis L

After bending of the elongate profiled strips 2 according to the embodiments, as illustrated in FIGS. 21a and 21b, the two ends 2a are connected together and therefore the cam 1 is formed.

### LIST OF REFERENCE NUMERALS

1 cam
2 profiled strip
2a end/end region
3 upper sheet
4 lower sheet
5 weld seam
6 joining contour
7 band thickness
8 feeder chamfer
9 region of low bending deformation
10 region of increased bending deformation
11 support shaft
12 widened region
13 winding mandrel
14 predetermined bending point, connection region
15 section contour
16 cutting tool
17 cutting tool
18 bending mandrel
19 calibration mandrel
20 forming tool
21 engraving, toothing
22 base of calibration mandrel
60 ₁ cone angle
α₂ cone angle
β₁ correction angle
β₂ correction angle
r radius of feeder chamfer
Q section plane
L longitudinal axis
WR rolling direction

1. Cams for built-up camshafts, formed from at least one profiled sheet metal strip which is produced by rolling, comprises different thicknesses in its longitudinal extension and has two end regions (2a), wherein the profiled sheet metal strip for forming the cam blank is bent or deformed such that its end regions (2a) abut and are welded together or that its end regions (2a) are welded to the end regions (2b) of at least one further bent or deformed sheet metal strip, wherein the cam blank comprises a cut-out for accommodating a support shaft, which cut-out comprises a substantially circular or circular portion-shaped inner contour region, characterized in that a feeder chamfer is formed on the inner contour region.

2. Cams as claimed in claim 1, characterized in that the feeder chamfer is introduced into the profiled sheet metal strip(s) by rolling.

3. Cams as claimed in claim 1, characterized in that the cam blank (1) is subjected to a pressure calibration step.

4. Cams as claimed in claim 3, characterized in that the feeder chamfer is formed during the pressure calibration step.

5. Cams as claimed in claim 3, characterized in that the feeder chamfer is introduced into the profiled sheet metal strip(s) at least partially by rolling and subsequently the final shape of the feeder chamfer is formed in the pressure calibration step.

6. Cams as claimed in claim 1, characterized in that the cam blank is formed from a single profiled sheet metal strip which is formed symmetrically or asymmetrically in relation to the transverse axis extending through the location of maximum cam elevation.

7. Cams as claimed in claim 1, characterized in that the cam blank comprises engraving at least on the inner wall of the cut-out for the purpose of forming a joining contour.

8. Cams as claimed in claim 7, characterized in that the engraving is formed by toothings which extend in the axial direction of the cam blank.

9. Cams as claimed in claim 1, characterized in that the feeder chamfer is formed as a portion, which widens conically outwards, of the inner contour of the cut-out.

10. Cams as claimed in claim 9, characterized in that the portion which widens conically outwards is subdivided into two partial portions widen conically and are disposed adjacent to one another in the axial direction, wherein the outer portion comprises a larger cone angle than the inner portion.

11. Cams as claimed in claim 10, characterized in that the cone angle (α₂) of the outer portion is between 5 and 10° and the cone angle (α₁) of the inner portion is between 0.5 and 4°.

12. Cams as claimed in claim 1, characterized in that the feeder chamfer is formed by a radius which is provided on the inner contour of the cut-out.

13. Cams as claimed in claim 1, characterized in that the feeder chamfer is formed by a parabolic portion which widens outwardly.

14. Cams as claimed in claim 1, characterized in that the circular or circular portion-shaped inner contour region extends over a peripheral region at a peripheral angle of at least 300°.

15. Rolled profiled sheet metal strip for the production of cams as claimed in any of claim 1, characterized in that an edge region of the profiled sheet metal strip is deformed by rolling such that after bending or deformation of the profiled sheet metal strip to form the cam blank this deformation forms the feeder chamfer of the cam blank.

16. Profiled sheet metal strip as claimed in claim 15, characterized in that each longitudinal portion of the profiled sheet metal strip is allocated to a peripheral portion of the cam blank and that the thickness progression in the longitudinal portions of the profiled sheet metal strip corresponds substantially to the thickness progression in the corresponding peripheral portions of the cam blank.

17. Profiled sheet metal strip as claimed in claim 15, characterized in that its two edge regions are deformed by rolling such that in relation to a perpendicular line with respect to the joining contour they comprise protruding regions which contain additional material to compensate for the transverse contraction of the material which occurs during bending or deformation of the profiled sheet metal strip to form the cam blank.

18. Profiled sheet metal strip as claimed in claim 15, characterized in that the longitudinal portion of the profiled sheet metal strip which corresponds to the subsequent joining contour of the bent or deformed cam blank comprises engraving which is introduced into the profiled sheet metal strip by rolling.

19. Profiled sheet metal strip as claimed in claim 18, characterized in that the rolled-in engraving is formed as a toothing which extends transversely with respect to the rolling direction.

20. Method of producing a cam for built-up camshafts, comprising the method steps of:
producing, by means of endless rolling and cutting to length, at least one profiled sheet metal strip which comprises thickness progressions predetermined in its longitudinal extension and has two end regions, wherein an edge deformation which forms a subsequent feeder chamfer of a cam blank is rolled at least partially onto a longitudinal edge of the profiled sheet metal strip; and
bending or deforming the profiled sheet metal strip, so that its end regions (2a) abut and are welded together or that its end regions (2a) abut and are welded to the end regions (2b) of at least one further bent or deformed sheet metal strip.

21. Method as claimed in claim 20, characterized in that the cam blank is subjected to a pressure calibration step.

22. Method as claimed in claim 21, characterized in that the partially rolled edge deformation of the profiled sheet metal strip is put into the final shape of the feeder chamfer during the pressure calibration step.

23. Method as claimed in claim 20, characterized in that the two edge regions of the profiled strip are deformed by rolling such that in relation to a perpendicular line with respect to the joining contour a protruding region is formed which contains additional material to compensate for the transverse contraction of the material which occurs during bending or deformation of the profiled sheet metal strip to form the cam blank.

24. Method as claimed in claim 20, characterized in that engraving (e.g. in the form of a toothing extending transversely with respect to the rolling direction) is rolled into the longitudinal portion of the profiled sheet metal strip which corresponds to the subsequent joining contour of the bent or deformed cam blank.

25. Method as claimed in claim 20, characterized in that the profiled sheet metal strips are produced by continuous rolling as portions of a endless sheet which can be wound, wherein the profiled sheet metal strips are connected by means of connection regions which comprise a smaller sheet metal thickness.

26. Built-up camshaft having cams as claimed in claim 1, wherein at the axial positions, at which the cams are to be attached, the support shaft comprises portions with a widened diameter, and wherein the cams are slid with the feeder chamfer to the fore onto the support shaft and are slid over the respective portion with the widened diameter thus forming a non-positive and/or positive connection between the cam and the support shaft.

27. Camshaft as claimed in claim 26, characterized in that the portions of widened diameter of the support shaft are produced by material displacement methods such as roller-burnishing or knurling.
